(19) United States
(12) Patent Application Publication
(10) Pub. No.: US 2025/0122059 A1
(43) Pub. Date: Apr. 17, 2025

(54) HANDLING MACHINE WITH A TANK CONTAINING PRESSURIZED GAS

(71) Applicant: MANITOU BF, ANCENIS (FR)

(72) Inventors: Hervé MERTEN, ANCENIS (FR); Mickaël MORON, ANCENIS (FR)

(21) Appl. No.: 18/715,593

(22) PCT Filed: Nov. 25, 2022
(86) PCT No.: PCT/EP2022/083365

§ 371 Date: Dec. 16, 2024

(30) Foreign Application Priority Data
Dec. 1, 2021 (FR) FR2112815

(51) Int. Cl. B66F 9/075; B60K 15/03; B60K 15/063; B60K 15/07; B66F 9/10

(52) U.S. Cl. CPC B66F 9/07518; B60K 15/07; B66F 9/07545; B66F 9/105; B60K 2015/03315; B60K 2015/0638

(57) ABSTRACT

A handling machine is provided. The handling machine includes a chassis, a front wheel shaft, a rear wheel shaft, two front wheels, two rear wheels, a load handling device, a driving cab, and at least one tank. The front wheel shaft and the rear wheel shaft extend transversely and are respectively fitted with the two front wheels and the two rear wheels. The load handling device is mounted on the front of the chassis. The driving cab is fastened to the chassis and is fitted with a seat. The driving cab includes a cab structure including two lateral arches, each lateral arch including a front upright and a rear upright connected to one another. The at least one tank is configured to contain pressurized gas, fastened to the chassis, and positioned between the rear upright of one of the lateral arches and one of the rear wheels.

### TECHNICAL FIELD

The invention relates to the field of handling machines.

The invention relates notably to a handling machine, such as a power lift truck, that is fitted with at least one tank containing pressurized gas.

### TECHNOLOGICAL BACKGROUND

Document U.S. Pat. No. 7,284,627 relates to a power lift truck fitted with one or more gas tanks. With reference to FIG. 1 thereof, this document sets out a prior art in which the gas tanks are disposed transversely and horizontally behind the driving cab of the power lift truck. This arrangement of the tanks creates visibility problems for the driver, notably when the power lift truck is moving in reverse. Furthermore, it does not enable the gas tanks to be satisfactorily protected. This document U.S. Pat. No. 7,284,627 proposes resolving these problems by arranging the gas tanks in a removable housing that is seated beneath the driver's seat. However, this arrangement is also not entirely satisfactory. This is because it reduces the ground clearance of the power lift truck and/or increases the height thereof. This is not possible for all types of power lift truck, and notably for all-terrain power lift trucks that require significant ground clearance and minimized height.

### SUMMARY

One idea at the heart of the invention is to propose a handling machine fitted with at least one tank containing pressurized gas wherein the arrangement of the tank does not adversely affect the driver's visibility and offers satisfactory protection for the tank, without reducing the ground clearance or increasing the height of the handling machine.

According to a first object, the invention proposes a handling machine including:
a chassis,
a front wheel shaft and a rear wheel shaft extending transversely and respectively fitted with two front wheels and two rear wheels,
a load handling device that is mounted on the front of the chassis,
a driving cab fastened to the chassis and fitted with a seat, the driving cab including a cab structure including two lateral arches, each lateral arch including a front upright and a rear upright that are connected to one another, and
at least one tank containing pressurized gas that is fastened to the chassis and positioned, at least in part, between the rear upright of one of the lateral arches and one of the rear wheels.

In other words, the tank includes at least one point located on a straight line joining a point of one of the rear wheels and a point of the rear upright of one of the lateral arches.

Therefore, the aforementioned arrangement of the tank means that the tank does not adversely affect the driver's visibility, notably when the machine is reversing, without thereby reducing the ground clearance or increasing the height of the handling machine. Furthermore, the tank is positioned outside the driving cab, which improves driver safety, notably in the event of a gas leak or fire.

According to some embodiments, such a handling machine may have one or more of the following features.

According to one embodiment, the driving cab is carried by the chassis between the front wheel shaft and the rear wheel shaft.

According to one embodiment, the lateral arch and the rear wheel between which the tank is positioned are disposed on the same side of the handling machine.

According to one embodiment, each rear upright includes an upper portion and a lower portion that are inclined in relation to one another, the lower portion being inclined rearward toward the upper portion, the tank being positioned between the lower portion of the rear upright and the rear wheel.

According to one embodiment, the upper portion of the rear uprights borders both sides of a rear window.

According to one embodiment, each front upright has an upper portion and a lower portion, the upper portion of the front upright bordering one of the lateral edges of a front windshield of the power lift truck and the lower portion of the front upright being arched to fit an upper portion of one of the front wheels.

According to one embodiment, each lateral arch includes an upper portion and a lower portion that extend substantially horizontally and that connect the rear upright and the front upright to one another.

According to one embodiment, the upper portion of the rear upright is inclined forwards from the lower portion.

According to one embodiment, the shape of the tank is a cylinder of revolution about a central axis X, said central axis X being inclined, from bottom to top, toward the rear. This helps to optimize the dimensions of the tank as a function of the geometry of the available space between the lower portion of the rear upright and the rear wheel.

According to one embodiment, the lower portion of the rear upright extends along an axis Y, and, in projection on a longitudinal plane, said axis Y and the central axis X are parallel to one another or together form an angle of less than 30°, advantageously less than 15°, and preferably less than 10°. This enables the dimensions of the tank to be further optimized.

According to one embodiment, the handling machine includes at least two tanks containing pressurized gas that are fastened to the chassis, the two tanks being positioned respectively between the rear upright of each of the lateral arches and one of the rear wheels. At least one tank is therefore positioned on each side of the handling machine.

According to one embodiment, the machine includes at least two tanks containing pressurized gas that are fastened to the chassis, the two tanks being positioned between the rear upright of one of the lateral arches and one of the rear wheels.

According to one embodiment, the shape of the two tanks is a cylinder of revolution respectively about a central axis X and a central axis X′, said central axes X and X′ being parallel to one another.

According to one embodiment, the central axes X and X′ are inclined rearward, from bottom to top.

According to one embodiment, in projection on a longitudinal plane, the axis Y and the central axes X are parallel or the axis Y forms with each of the central axes X and X′ an angle of less than 30°, advantageously less than 15°, and preferably less than 10°. This helps to optimize the dimensions of the tanks as a function of the geometry of the available space between the lower portion of the rear upright and the rear wheel.

According to one embodiment, the central axis X of the tank extends substantially in a longitudinal plane passing through one of the front wheels and through one of the rear wheels, said front and rear wheels being disposed on the same side of the handling machine.

According to one embodiment, the handling machine further includes a rear compartment fastened to the chassis behind the driving cab.

According to one embodiment, the handling machine further includes a motor that is designed to move the power lift truck.

According to one embodiment, the motor is housed in the rear compartment.

According to one embodiment, the motor is coupled to at least one of the front and rear wheel shafts, and preferably to both front and rear wheel shafts, via a transmission device.

According to one embodiment, the motor is a heat engine that is connected to the at least one tank by a supply circuit and that is intended to be supplied with gas contained in said tank.

According to another embodiment, the tank contains hydrogen and the motor is an electric motor that is connected to an electric power supply system, the electric power supply system including a fuel cell that is connected to the at least one tank by a supply circuit and that is intended to be supplied with the hydrogen contained in said tank.

According to one embodiment, the electric power supply system further comprises an energy storage device comprising one or more batteries and/or one or more supercapacitors.

According to one embodiment, the fuel cell and/or the energy storage device are housed in the rear compartment.

According to one embodiment, the at least one tank contains one of the following gases: liquefied natural gas (LNG), liquefied petroleum gas (LPG), and hydrogen.

According to one embodiment, the tank contains hydrogen and is suitable for storing hydrogen in the gaseous state at a maximum pressure of between 300 and 700 bar, for example of the order of 350 bar.

According to one embodiment, the rear compartment includes a cover and one or more tanks containing pressurized gas that are positioned horizontally and transversely, and fastened to said cover.

According to one embodiment, the load handling device is a lifting mast.

According to one embodiment, the handling machine is a power lift truck.

According to one embodiment, the lifting mast includes a carriage on which the forks are fastened and that is mounted movably along the lifting mast.

According to one embodiment, the rear wheels are steered.

According to one embodiment, the rear wheels have a smaller diameter than the front wheels. This improves the handling of the handling machine. Furthermore, this creates a space between at least one of the rear wheels and the rear upright of one of the lateral arches that is large enough to receive a tank.

According to one embodiment, the lateral arches are connected to one another by cross members.

According to one embodiment, the ground clearance of the handling machine is greater than 160 mm, and preferably greater than 250 mm.

### BRIEF DESCRIPTION OF THE FIGURES

The invention will be better understood, and further objects, details, features and advantages thereof will become more clearly apparent, through the following description of a number of particular embodiments of the invention, these being given solely by way of nonlimiting illustration, and with reference to the attached drawings.

FIG. 1 shows a power lift truck according to a first embodiment.

FIG. 2 shows a power lift truck according to a second embodiment.

FIG. 3 shows a power lift truck according to a third embodiment.

FIG. 4 is a schematic view of the power train of the power lift truck according to a first variant embodiment.

FIG. 5 is a schematic view of the power train of the power lift truck according to a second variant embodiment.

### DESCRIPTION OF THE EMBODIMENTS

By convention, the “longitudinal” direction of the handling machine corresponds to the front-rear orientation of the machine. Furthermore, the terms “rear” and “front”, respectively denoted as “R” and “F” in the figures, are used to define the relative position of one element with respect to another in the longitudinal direction. The “transverse” direction is oriented perpendicular to the longitudinal direction.

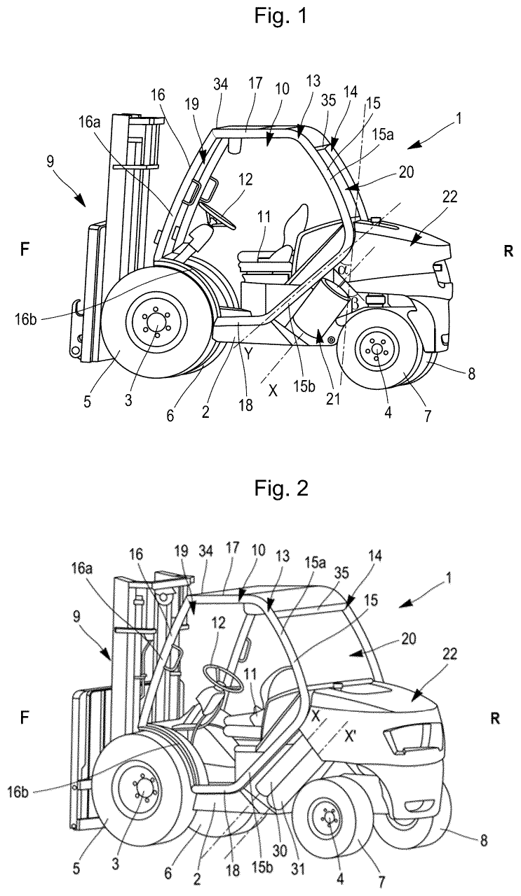

A handling machine that is a power lift truck 1 is described according to a first embodiment with reference to FIG. 1.

The power lift truck 1 includes a chassis 2 that is mobile. To achieve this, the power lift truck 1 has two wheel shafts: a front wheel shaft 3 and a rear wheel shaft 4, which are each mounted on the chassis 2 along a transverse axis and are each equipped with two wheels, one on the left 5, 7, and the other on the right 6, 8. At least one of the front wheel shaft 3 and the rear wheel shaft 4 is movable in rotation on the chassis 2. Preferably, both the front wheel shaft 3 and the rear wheel shaft 4 are mounted movably in rotation on the chassis 2 and are coupled to a motor to move the power lift truck 1. In this case, the power lift truck 1 can be described as an all-terrain power lift truck, i.e. with four drive wheels.

Advantageously, the rear wheels 7, 8 are steered and have a smaller diameter than the front wheels 5, 6. This optimizes grip and provides a smaller turning radius for improved handling of the power lift truck 1.

The power lift truck 1 includes a load handling device 9 that is mounted on the front of the chassis 2. The load handling device 9 is in this case a lifting mast that is carried at the front of the chassis 2 and that includes a carriage on which the tool or tools, such as a fork, are fastened, and that is mounted movably vertically along the lifting mast between a lowered end position and a raised end position. The lifting mast may be driven hydraulically using one or more hydraulic rams or by chains using a hydraulic motor.

Furthermore, the power lift truck 1 includes a driving cab 10 that is carried by the chassis 2 between the front wheel shaft 3 and the rear wheel shaft 4. This driving cab 10 is provided with a driving position comprising a seat 11 on which the driver can sit to drive the power lift truck 1. The driving position also includes equipment for controlling the power lift truck 1, such as a steering wheel 12, an accelerator pedal, a brake pedal, and a control lever for the load handling device 9.

The driving cab 10 includes a cab structure including two lateral arches 13, 14 that notably help to protect the driver if the power lift truck 1 overturns. The lateral arches 13, 14 are connected to one another by cross members 34, 35. Each of the lateral arches 13, 14 extends substantially in a vertical plane parallel to the longitudinal direction of the power lift truck 1.

Each of the lateral arches 13, 14 includes a rear upright 15, a front upright 16, as well as an upper portion 17 and a lower portion 18 that extend substantially horizontally. The upper portion 17 connects the upper ends of the rear upright 15 and of the front upright 16, whereas the lower portion 18 connects the lower ends of the rear upright 15 and of the front upright 16.

The front upright 16 includes an upper portion 16a that borders one of the lateral edges of the front windshield 19 of the power lift truck 1 and a lower portion 16b that is arched to fit an upper portion of one of the front wheels 5, 6.

Furthermore, the rear upright 15 includes an upper portion 15a and a lower portion 15b that are inclined in relation to one another. The upper portion 15a is inclined forwards from the lower portion 15b. This portion borders one of the lateral edges of the rear window 20 of the power lift truck 1. The lower portion 15b of the rear upright 15 is inclined rearward from the lower portion 18 of the lateral arch 13, 14 toward the upper portion 15a. The lower portion 18 of the lateral arch 13, 14 is thus disposed in the longitudinal direction of the power lift truck 1 between one of the front wheels 5, 6 and one of the rear wheels 7, 8. The lower portion 15b of the rear upright 15 extends globally along an axis Y that, in projection on a longitudinal plane, is inclined at an angle a in relation to a vertical axis of said longitudinal plane.

The power lift truck 1 also includes one or more tanks 21 intended to contain pressurized gas. The tank or tanks 21 may notably contain one of the following gases: liquefied natural gas (LNG), liquefied petroleum gas (LPG), and hydrogen. The shape of the tank 21 is a cylinder of revolution about a central axis X.

In the variant embodiment in which the stored gas is hydrogen, the tank 21 is suitable for storing hydrogen in the gaseous state at a maximum pressure of between 300 and 700 bar, for example of the order of 350 bar.

At the rear of the driving cab 10, the power lift truck 1 includes a rear compartment 22 that is intended to house at least one motor designed to move the power lift truck 1.

In the embodiment illustrated in FIG. 1, the tank 21 is fastened to the chassis 2 and is positioned between the rear upright 15 of one of the lateral arches 13, 14 and the rear wheel 7, 8 that is disposed on the same side of the power lift truck 1 as said lateral arch 13, 14. The tank 21 is more specifically positioned at the front of the rear compartment 22, and axially between the lower portion 15b of the rear upright 15 of one of the lateral arches 13, 14 and the corresponding rear wheel 4. The tank 21 is thus positioned outside the driving cab 10, which ensures driver safety, notably in the event of a gas leak or fire.

The central axis X of the tank extends substantially in a longitudinal plane parallel to the longitudinal axis of the power lift truck 1. This longitudinal plane advantageously passes through one of the front wheels 5, 6 and through one of the rear wheels 7, 8. Furthermore, in projection on said longitudinal plane, the central axis X of the tank 21 is inclined by an angle B in relation to a vertical axis. The tank 21 is inclined in the same direction as the rear portion 15b of the rear upright 15 of the lateral arch 13, 14, i.e. from bottom to top, toward the rear of the power lift truck 1. Considered in projection on a longitudinal plane, the axes X and Y are parallel or together form an angle of less than 30°, advantageously less than 15°, and preferably less than 10°. This helps to optimize the dimensions of the tank 21 as a function of the available space between the lower portion 15b of the rear upright 15 and the rear wheel 4.

This positioning of the tank 21 does not reduce the ground clearance of the power lift truck 1, as in the prior art. The ground clearance is thus advantageously greater than 160 mm, preferably greater than 250 mm and for example of the order of 320 mm.

Advantageously, the power lift truck 1 includes a tank 21, as described above, on each side of the power lift truck 1.

FIG. 4 is a schematic view of the power train of the power lift truck 1 according to a first variant embodiment. The power train includes a motor 23 that is coupled to at least one of the wheel shafts 3, 4 and advantageously to both wheel shafts 3, 4 by a transmission device 24. According to a variant embodiment, the transmission device 24 is a mechanical device. Alternatively, the transmission device 24 is a hydraulic transmission device. In this case, the motor 23 is coupled to a pump that drives hydraulic motors for each of the two wheel shafts 3, 4.

In this embodiment, the motor 23 is a combustion engine that is connected to the tank or tanks 21 by a supply circuit 25 and that is supplied with the gas stored in the tank or tanks 21.

According to one embodiment, the motor 23 is coupled to a pump enabling the hydraulic actuation of the lifting mast. According to another embodiment, the power lift truck 1 includes another motor, for example an electric motor, that is coupled to the pump enabling the hydraulic actuation of the lifting mast.

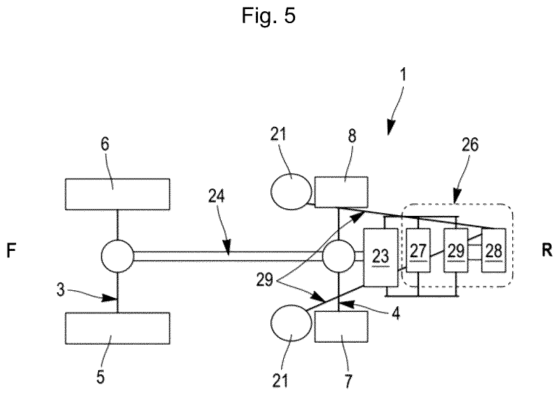

FIG. 5 is a schematic view of the power train of the power lift truck 1 according to a second variant. The motor 23 is also coupled to at least one of the wheel shafts 3, 4 and advantageously to both wheel shafts 3, 4 by a transmission device 24. In this embodiment, the motor 23 is an electric motor. This motor is powered by an electric power supply system 26.

The electric power supply system 26 notably comprises an energy storage device 27 comprising one or more batteries and/or one or more supercapacitors.

The electric power supply system 26 also includes a fuel cell 28. The fuel cell 28 and the energy storage device 27 are electrically connected, on the one hand, to one another and, on the other hand, in parallel to the motor 23.

The fuel cell 28 is connected to the tank or tanks 21 by a supply circuit 29 and is thus intended to be supplied with the hydrogen stored in the tank or tanks 21. The supply circuit 29 is notably fitted with an expansion valve to lower the pressure of the hydrogen. The fuel cell 28 is further equipped with an air supply compressor able to compress the oxidant air at the inlet to the cells of the fuel cell 28. The fuel cell 28 may also comprise a humidifier device able to humidify the hydrogen and the air at the inlet to the fuel cell 28.

The electric power supply system 26 further comprises a DC/DC voltage converter 29 that is connected, on the one hand, to the fuel cell 28 and, on the other hand, to the motor 23 and to the energy storage device 27. The DC/DC voltage converter 29 is able to convert the level of voltage delivered by the fuel cell 28 to the level of voltage required by the motor 27 and the energy storage device 27.

In a known manner, such a fuel cell 28 is where an oxidation-reduction reaction takes place to convert the hydrogen from the pressurized gas tank 21 and the oxygen from the air into electricity, water and heat. According to one embodiment, the electric power supply system 26 is also housed in full or in part in the rear compartment 22.

According to one embodiment, the motor 23 is coupled to a pump enabling the hydraulic actuation of the lifting mast. According to another embodiment, the power lift truck 1 also includes a dedicated electric motor (not shown) that is connected to the electric power supply system 26 and is coupled to a pump enabling the hydraulic actuation of the lifting mast.

FIG. 2 shows a power lift truck 1 according to a second embodiment. This embodiment differs from the embodiment described above with reference to FIG. 1 in that two tanks 30, 31 containing pressurized gas are placed between the rear upright 15 of one of the lateral arches 13, 14 and the corresponding rear wheel 7, 8. The central axes X and X′ of the two pressurized gas tanks 30, 31 are disposed parallel to one another. The central axes X and X′ extend substantially in a longitudinal plane. Furthermore, as in the embodiment in FIG. 1, each of the tanks 30, 31 is inclined in the same direction as the rear portion 15b of the rear upright 15 of the lateral arch 13. In other words, the axes X and X′ are parallel to Y or form an angle with said axis Y of less than 30°, advantageously less than 15°, and preferably less than 10°.

Advantageously, the power lift truck 1 includes two tanks 30, 31, as described above, on each side of the power lift truck 1.

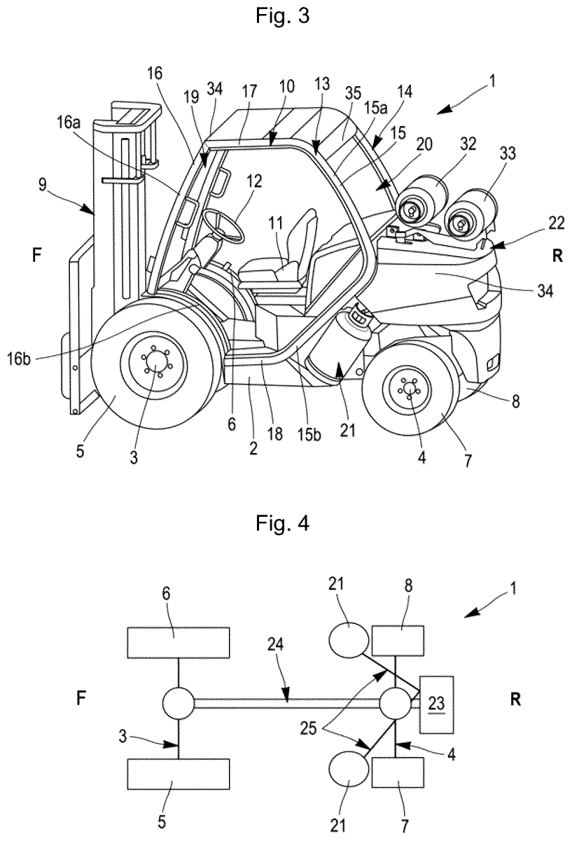

FIG. 3 shows a power lift truck 1 according to a third embodiment. This embodiment differs from the embodiment in FIG. 1 in that it further includes one or more tanks 32, 33 containing pressurized gas that are positioned horizontally and transversely, and fastened to the cover 34 of the rear compartment 22. This enables the gas storage capacity to be increased without excessively reducing the driver's visibility.

Although the invention has been described in relation to several specific embodiments, it evidently is in no way limited thereto and includes all of the technical equivalents of the means described and the combinations thereof where these fall within the scope of the invention, as defined in the claims.

The use of the verbs “comprise”, “include” or “have” and the conjugated forms thereof does not exclude the presence of elements or steps other than those listed in a claim.

In the claims, any reference symbol between parentheses must not be interpreted as a limitation on the claim.

1. A handling machine including:
a chassis;
a front wheel shaft and a rear wheel shaft extending transversely and respectively fitted with two front wheels and two rear wheels;
a load handling device that is mounted on the front of the chassis;
a driving cab fastened to the chassis and fitted with a seat, the driving cab including a cab structure including two lateral arches, each lateral arch including a front upright pillar and a rear upright pillar that are connected to one another; and
at least one tank containing pressurized gas that is fastened to the chassis and positioned, at least in part, between the rear upright pillar of one of the lateral arches and one of the rear wheels.

2. The handling machine of claim 1, wherein each rear upright pillar includes an upper portion and a lower portion that are inclined in relation to one another, the lower portion being inclined rearward toward the upper portion, and wherein the tank is positioned between the lower portion of the rear upright pillar and the respective rear wheel.

3. The handling machine of claim 2, wherein the tank is shaped as a cylinder of revolution about a central axis, the central axis being inclined, from bottom to top, toward a rear.

4. The handling machine of claim 3, wherein the lower portion of the rear upright pillar extends along a second axis, and wherein, in projection on a longitudinal plane, he second axis and the central axis are parallel to one another or together form an angle of less than 30°.

5. The handling machine of claim 1, including at least two tanks containing pressurized gas that are fastened to the chassis, the two tanks being positioned respectively between the rear upright pillar of each of the lateral arches and one of the rear wheels.

6. The handling machine of claim 1, including at least two tanks containing pressurized gas that are fastened to the chassis, the two tanks being positioned between the rear upright pillar of one of the lateral arches and one of the rear wheels.

7. The handling machine of claim 6, wherein
the two tanks are shaped as a cylinder of revolution respectively about a first central axis and a second central axis, and
the first central axis and the second central axis are parallel to one another.

8. The handling machine of claim 1, further including a rear compartment fastened to the chassis behind the driving cab.

9. The handling machine of claim 8, further including a motor that is designed to move the handling machine and that is housed in the rear compartment.

10. The handling machine of claim 8, wherein the rear compartment includes a cover and further includes one or more tanks containing pressurized gas that are positioned horizontally and transversely, and fastened to the cover.

11. The handling machine of claim 1, wherein the at least one tank contains one of the following gases: liquefied natural gas (LNG), liquefied petroleum gas (LPG), and hydrogen.

12. The handling machine of claim 1, wherein the load handling device is a lifting mast.

13. A handling machine including:
a wheel shaft;
a wheel rotatably mounted to the wheel shaft;
a driving cab including a lateral arch having an upright pillar; and
a tank configured to contain pressurized gas between the upright pillar and the wheel.

14. The handling machine of claim 13, wherein
the upright pillar includes an upper portion and a lower portion,
the lower portion is inclined rearwardly toward the upper portion, and
the tank is positioned between the lower portion and the wheel.

15. The handling machine of claim 14, wherein
the tank is cylindrical and defines a central axis, and
the central axis is inclined.

16. The handling machine of claim 15, wherein
the lower portion of the upright pillar extends along a second axis, and
the second axis and the central axis form an angle of less than 30°.

17. The handling machine of claim 13, wherein
the tank is a first tank,
the lateral arch is a first lateral arch,
the upright pillar is a first upright pillar,
the wheel is a first wheel,
a second wheel is mounted to the wheel shaft,
the driving cab includes a second lateral arch having a second upright pillar, and
a second tank configured to contain pressurized gas is between the second upright pillar and the second wheel.

18. The handling machine of claim 13, wherein
the tank is a first tank, and
a second tank configured to contain pressurized gas is between the upright pillar and the wheel.

19. The handling machine of claim 18, wherein
the first tank defines a first central axis,
the second tank defines a second central axis, and
the first central axis is parallel to the second central axis.

20. The handling machine of claim 13, wherein a compartment is positioned behind the driving cab.
